(19) United States
(12) Patent Application Publication
(10) Pub. No.: US 2013/0268364 A1
(43) Pub. Date: Oct. 10, 2013

(54) Method and System for Facilitating a Transaction Between an Individual and a Small Advertiser Through a Target-Oriented Marketing Campaign

(71) Applicant: Andrew Gildfind, Brixton (GB)

(72) Inventor: Andrew Gildfind, Brixton (GB)

(21) Appl. No.: 13/553,745

(22) Filed: Jul. 19, 2012

Related U.S. Application Data
(60) Provisional application No. 61/621,285, filed on Apr. 6, 2012.
(60) Provisional application No. 61/621,299, filed on Apr. 6, 2012.

(51) Int. Cl. G06Q 30/02

(52) U.S. Cl. 705/14.57

(57) ABSTRACT

A method of facilitating a transaction between an individual and a small advertiser through a target-oriented marketing campaign comprises: causing a display of a target-oriented marketing message on a client device to a viewer at the client device, the message including one or more keywords characterizing a product or service offered by a small advertiser located within a predefined distance from the client device; receiving a response from the viewer to purchase the product or service, wherein the response is generated in response to the viewer's selection of a unique campaign attribute in the target-oriented marketing message; and in response to the viewer's response: generating a unique transaction identifier in accordance with a predefined protocol specified by the small advertiser; providing the unique transaction identifier to the viewer; and applying a predefined service charge to an account associated with the small advertiser.

### CROSS REFERENCE TO RELATED APPLICATION

This application claims priority to U.S. Provisional Patent Application No. 61/621,285, filed Apr. 6, 2012, entitled “Method and System for Launching a Generic Marketing Campaign by Pooling Small Advertisers,” which is incorporated by reference in its entirety.

This application claims priority to U.S. Provisional Patent Application No. 61/621,299, filed Apr. 6, 2012, entitled “Method and System for Facilitating a Transaction between an Individual and a Small Advertiser Through a Target-Oriented Marketing Campaign,” which is incorporated by reference in its entirety.

This application is related to U.S. patent application Ser. No. ______, filed Jul. 19, 2012, entitled “Method and System for Launching a Generic Marketing Campaign by Pooling Small Advertisers” (attorney docket no. 060963-5655-US).

### TECHNICAL FIELD

The disclosed implementations relate generally to a TV/web advertisement, and in particular, to system and method for facilitating a transaction between an individual and a small advertiser through a target-oriented marketing campaign.

### BACKGROUND

Although TV advertisement has proved to be effective for promoting products or services and, in particular, for increasing their name recognition, the cost for launching a large-scale TV commercial campaign is undoubtedly high and beyond the reach to a large number of small advertisers. For example, a 30-second TV commercial time slot at the 2012 Super Bowl game would cost an advertiser more than three million dollars. On the other hand, there are a large number of businesses (mainly small ones) whose business model is not that brand-centric. For example, although branding is not unimportant, people who visit a small, local pizzeria or dry cleaning store are often motivated by the generic nature of the product or service provided by these stores (e.g., they are looking for good quality and low cost). But thus far, little effort has been made to reduce the barrier for small business owners to benefit from the massive power of TV advertisement for promoting their products or services to the general public.

Moreover, it is hard to measure the success of TV advertisement because a massive TV marketing campaign usually covers a large viewership for a certain time period and it is difficult to tell how much influence it has on individual viewers by associating the campaign with their commercial activities. Although this issue might be less of a concern for those large advertisers who use the TV advertisement for brand building, it would be difficult for those small advertisers to divert their limited resource to a marketing tool whose effectiveness cannot be measured using reliable and tangible numbers.

### SUMMARY

In accordance with some implementations described below, a method of facilitating a transaction between an individual and a small advertiser through a target-oriented marketing campaign is implemented at a server system having memory and one or more processors. The method comprises: causing a display of a target-oriented marketing message on a client device to a viewer at the client device, wherein the target-oriented marketing message includes one or more keywords characterizing a product or service offered by a small advertiser located within a predefined distance from the client device; receiving a response from the viewer to purchase the product or service offered by the small advertiser at a price specified in the target-oriented marketing message, wherein the response is generated in response to the viewer's selection of a unique campaign attribute in the target-oriented marketing message; and in response to the viewer's response: generating a unique transaction identifier in accordance with a predefined protocol specified by the small advertiser; providing the unique transaction identifier to the viewer; and applying a predefined service charge to an account associated with the small advertiser.

In accordance with some implementations described below, a computer server system for facilitating a transaction between an individual and a small advertiser through a target-oriented marketing campaign is disclosed, the computer system having memory for storing one or more programs and one or more processors for executing the one or more programs. The one or more programs include instructions for: causing a display of a target-oriented marketing message on a client device to a viewer at the client device, wherein the target-oriented marketing message includes one or more keywords characterizing a product or service offered by a small advertiser located within a predefined distance from the client device; receiving a response from the viewer to purchase the product or service offered by the small advertiser at a price specified in the target-oriented marketing message, wherein the response is generated in response to the viewer's selection of a unique campaign attribute in the target-oriented marketing message; and in response to the viewer's response: generating a unique transaction identifier in accordance with a predefined protocol specified by the small advertiser; providing the unique transaction identifier to the viewer; and applying a predefined service charge to an account associated with the small advertiser.

In accordance with some implementations described below, a computer readable-storage medium storing one or more programs for execution by one or more processors of a computer server system for facilitating a transaction between an individual and a small advertiser through a target-oriented marketing campaign is disclosed. The one or more programs include instructions for: causing a display of a target-oriented marketing message on a client device to a viewer at the client device, wherein the target-oriented marketing message includes one or more keywords characterizing a product or service offered by a small advertiser located within a predefined distance from the client device; receiving a response from the viewer to purchase the product or service offered by the small advertiser at a price specified in the target-oriented marketing message, wherein the response is generated in response to the viewer's selection of a unique campaign attribute in the target-oriented marketing message; and in response to the viewer's response: generating a unique transaction identifier in accordance with a predefined protocol specified by the small advertiser; providing the unique transaction identifier to the viewer; and applying a predefined service charge to an account associated with the small advertiser.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a block diagram illustrating a TV advertisement delivery system including one or more TV program broadcasters, a TV marketing campaign server, and a plurality of client devices that are communicatively coupled to the TV marketing campaign server through a communication network in accordance with some implementations.

FIG. 2 is a block diagram illustrating the components of the TV marketing campaign server configured for launching a generic, brand-neutral marketing campaign for a plurality of small advertisers in accordance with some implementations.

FIGS. 3A to 3C are block diagrams illustrating data structures used by the TV marketing campaign server for launching a generic, brand-neutral marketing campaign for a plurality of small advertisers and facilitating a target-oriented commercial transaction between an individual and a small advertiser in accordance with some implementations.

FIG. 3D is a block diagram illustrating a data structure used by a client device for submitting a search request for a product or service promoted by a generic, brand-neutral marketing campaign in accordance with some implementations.

FIGS. 4A to 4C are flow charts illustrating how the TV marketing campaign server launches a generic, brand-neutral marketing campaign for a plurality of small advertisers in accordance with some implementations.

FIG. 5 is a flow chart illustrating how the TV marketing campaign server facilitates a transaction between an individual and a small advertiser through a target-oriented marketing campaign in accordance with some implementations.

FIGS. 6A and 6B are two exemplary user interfaces of campaign messages in accordance with some implementations.

### DETAILED DESCRIPTION

From the perspective of small advertisers, conventional TV advertising has significant shortcomings, such as high cost and the difficulty of targeting likely customers and determining the effectiveness of advertising campaigns. Herein, implementations of a hybrid TV/web advertising approach are described that overcome or mitigate at least some of these issues associated with conventional TV advertising. For example, in some implementations of the hybrid approach, a large number of small advertisers pool their financial resources to sponsor/participate in a mass-market TV marketing campaign. The TV marketing campaign includes TV advertisements that promote a general product class, such as pizza restaurants, dry cleaners, or barbers, as just a few examples. In some implementations, the TV advertisements include a URL or keyword(s) (or equivalent resource identifier) that is uniquely associated with the hybrid advertising campaigning. When a viewer of such an advertisement indicates an interest in the advertised class of goods by entering the keyword in a search engine/toolbar or navigating to the website identified by the URL, that viewer is directed to a local participant in the campaign (e.g., based on location information of the viewer, such as their IP address or GPS location). Finally, the hybrid approach tracks participant transactions that can be attributed to the marketing campaign to enable small advertisers to evaluate the effectiveness of this approach relative to their investment in the hybrid marketing campaign.

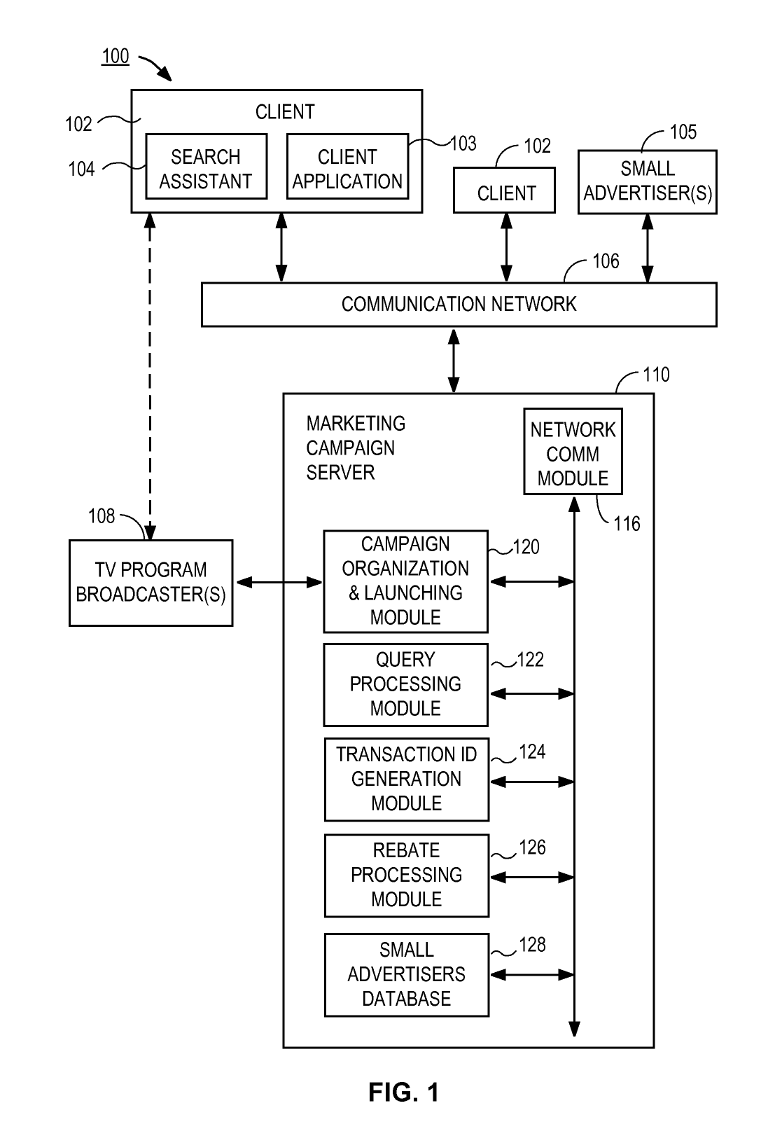

FIG. 1 is a block diagram illustrating a TV advertisement delivery system including one or more TV program broadcasters 108, a TV marketing campaign server 110, and a plurality of client devices 102 (some of which being used by small advertisers 105) that are communicatively coupled to the TV marketing campaign server 110 through a communication network 106 in accordance with some implementations.

The marketing campaign server 110 includes a campaign organization and launching module 120 for pooling together the financial resources collected from the small advertisers 105. For example, assume that the marketing campaign server 110 is charged with organizing a marketing campaign for a large number of small pizza stores. To do so, the campaign organization and launching module 120 sends out an invitation message to potential small advertisers using their contact information stored in the small advertisers database 128. For example, the message includes a general introduction to the campaign and a hyperlink to a website that provides more details of the campaign and enables an interested party to register to participate in the campaign. In some implementations, the website hosts a number of marketing campaigns for different products and services and a small advertiser can visit the website regularly to review those campaigns that may be valuable to its business growth.

In some implementations, the hybrid TV/web marketing approach and technology disclosed herein is used for promoting those products or services that are relatively brand neutral. Stated differently, some implementations are used to promote a generic subject (e.g., class of goods and/or services) shared by the small advertisers that participate in the marketing campaign. For example, as all dry cleaning stores provide dry cleaning services, individual dry cleaning stores should expect more business from a marketing campaign promoting drying cleaning services generally. Similarly, as most pizza restaurants/stores sell cheese pizzas, individual pizza stores should benefit from a marketing campaign targeting cheese pizza. On the other hand, as there is little in common between the business of dry cleaning stores and that of pizza stores, it would not make sense to organize a campaign for both types of business (though a hybrid TV campaign could conceivably be arranged to promote different types of small businesses in a particular geographic area, such as a particular downtown or shopping district, which is especially the case if the broadcast of the hybrid campaign is limited to audiences living in the particular geographic area).

Besides a generic subject, a successful marketing campaign should enroll a sufficient number of advertisers to cover the cost of purchasing time slots from TV broadcasters 108. Moreover, in some embodiments, the geographical distribution of the advertisers participating in the marketing campaign should have a substantial regional or national coverage depending on whether the marketing campaign is to be broadcast in a region or a nation respectively. In other words, it does not serve the marketing purpose of a hybrid campaign if many viewers of the campaign cannot find locally a small business/advertiser that provides the products or services promoted by the campaign.

In some implementations, the campaign organization and launching module 120 is responsible for soliciting participants in a marketing campaign from a pool of candidate small advertisers, registering information of participant advertisers, including location, contact information, and the amount of money paid by the advertisers, and finally deciding whether there are enough advertisers participating in the hybrid campaign to provide sufficient coverage of the region targeted by the campaign. In some instances, the campaign organization and launching module 120 may automatically decide not to launch the campaign if there is not enough participation for a certain region according to predefined criteria. In some other cases, the decision of not launching a campaign may involve a human component. If there are too many interested advertisers within a given geographical region, the campaign organization and launching module 120 may allocate the limited seat(s) for participation in that region via an auction process. In some implementations, when multiple advertisers agree to pay substantially the same amount of money, a winner can be chosen by the campaign organization and launching module 120 through a random process (such as a blind draw).

After organizing a marketing campaign and selecting participants, the campaign organization and launching module 120 sends the associated advertisement(s) to the TV broadcasters 108, who broadcast the marketing campaign to its audience via a client device 102 that receives over-the-air, cable, and/or satellite TV signals. In some implementations, the client device 102 is a connected TV with access to the Internet (e.g., a TV coupled to a set-top-box), a desktop or laptop or tablet computer, or a mobile device such as a smart phone. The client device 102 further includes a client application 103 (e.g., a web browser) and a search assistant 104 that interacts with the marketing campaign server 110. In some implementations, the advertisement(s) associated with the hybrid campaign includes one or more predefined parameters that identify the campaign, such as a keyword(s), campaign web page URL, campaign ID, Quick Response (QR) code, etc. In a typical scenario, after watching the marketing campaign a user of the client device 102 who is interested in purchasing the product or service promoted by the hybrid marketing campaign submits a search query to the marketing campaign server 110 related to the campaign. In some implementations, the user search query includes one or more search terms for identifying the marketing campaign (e.g., the one or more predefined parameters, such as a campaign ID). By including a predefined parameter as a search term, the marketing campaign server 100 is able to distinguish search queries that are driven by the marketing campaign from other search queries. As described below, this predefined parameter allows the effectiveness of the marketing campaign to be measured and thereby validated to advertisers that participate in the campaign.

Upon receipt of the search query, a query processing module 122 in the marketing campaign server 110 processes the query to determine which participant advertiser, if any, to promote to the user at the client device 102 based on the location of the client device 102. In some implementations, the query processing module 122 identifies an advertiser for servicing the client device 102 based on a set of predefined rules, one of which defines a maximum distance between a client device and a small advertiser, which, in many cases, derives most of its business from a local community. In some implementations, the query processing module 122 identifies the device location based on an IP address of the device, location of one or more Wi-Fi or mobile transmitters proximate to the client device, GPS location provided by the device, or other location information (such as user search preferences or account settings). It should be noted that the location information is provided to the query processing module 122 with a prior voluntary approval from a user of the client device who can opt out of this service at any time. In some implementations, the location information is provided to the query processing module 122 on an anonymous basis. For example, the rule may specify that the distance between the client device and a promoted small advertiser should be less than five miles. If at least one advertiser is identified as satisfying the predefined rules, the query processing module 122 then prepares a response including the identified advertiser and returns the response to the requesting client device 102. If no advertiser is found to be within five miles from the client device, the marketing campaign server 110 may report back to the client device 102 accordingly or, by default, return one or more local search results generated by a search engine based on the search query and the location of the client device 102.

After receiving a response from the marketing campaign server 110 that includes information on one or more small advertisers that are campaign participants, the user may choose to purchase products or services from one of the advertisers. In some implementations, the response returned to the user is a web page including one or more entries, each entry corresponding to a particular advertiser. A user selection of a particular entry sends a purchase request to the marketing campaign server 110. Within the marketing campaign server 110, a transaction ID generation module 124 generates a transaction identifier for the purchase request. In some implementations, the transaction identifier is in the form of a purchase coupon redeemable at the particular advertiser. For example, as part of the promotion, the marketing campaign may include a coupon code that gives a 20% discount to any customers that watch the campaign on the TV and follow the campaign's instruction to order products or services provided by the campaign sponsors (i.e., small advertisers that have participated in the campaign). The transaction ID generation module 124 returns the purchase coupon to the client device 102 so that the user at the client device 102 can print a copy of the coupon. In some implementations, the transaction ID generation module 124 returns the purchase coupon (or a hyperlink to the purchase coupon) in an email message to the requesting user if the user provides an email address for delivering the coupon. By providing a user with a discount for returning a coupon, the user is more likely to use the coupon, and therefore both the seller and the hybrid marketing campaign manager are more likely to gain updated information on the effectiveness of the hybrid marketing campaign. In some implementations, the user does not need any further assistance from the marketing campaign server 110 to redeem a coupon at a corresponding advertiser (e.g., a pizza store or a dry cleaning store) to purchase the promoted product or service. On the other hand, the original contribution by the participant advertisers of a marketing campaign is usually insufficient for covering the TV broadcasting cost. Therefore, the marketing campaign server 110 may charge a service fee to a participant advertiser for every delivered coupon because, if a user chooses to receive a coupon for the discounted product or service, it is very likely that the user will redeem the coupon at the participant advertiser. In order to encourage more advertisers to use the marketing tool, in some implementations the marketing campaign server 110 gives a rebate of a certain amount back to an advertiser when the advertiser submits all the purchase coupons that the marketing campaign server 110 has generated and the customers have redeemed for the products or services offered by the advertiser. To do so, the transaction ID generation module 124 generates a unique transaction ID (e.g., a 1-D or 2-D bar code) for each client request and includes the unique transaction ID in a purchase coupon to be returned to the requesting client device. When a customer redeems the coupon for the advertiser's product or service, the advertiser submits the unique transaction ID to the marketing campaign server 110 by, e.g., scanning the bar code on the coupon. For each received and authenticated transaction ID, the marketing campaign server 110 returns a rebate to the advertiser. There are other rebate schemes available for encouraging the advertisers to use this marketing tool. For example, the amount of rebate may be dependent on the number of coupons redeemed such that the more coupons redeemed at an advertiser the more rebates the advertiser receives. In some implementations, an advertiser does not know the algorithm for generating the unique transaction ID. Therefore, it cannot “game” the marketing campaign server 110 using faked or expired transaction IDs to claim rebates that it is not entitled to.

Besides being an incentive for advertisers to use the marketing tool, the process of generating a unique transaction ID for each purchase coupon and providing a rebate for each redeemed coupon is also a more reliable mechanism for predicting the effectiveness of the marketing campaign than the commonly used measure of the number of impressions of the TV-based marketing campaign by viewers, which is a large-scale but statistically imprecise estimate of its effectiveness. The unique transaction ID is a more accurate measure of viewers' interest in the promoted products or services at a particular advertiser based on the number of coupon delivered and this measure also can be used to determine a final count of commercial transactions attributable to the marketing campaign. In sum, by employing a unique transaction in conjunction with a hybrid marketing campaign an advertiser is given a clear picture of the effectiveness of a marketing campaign in which it has participated.

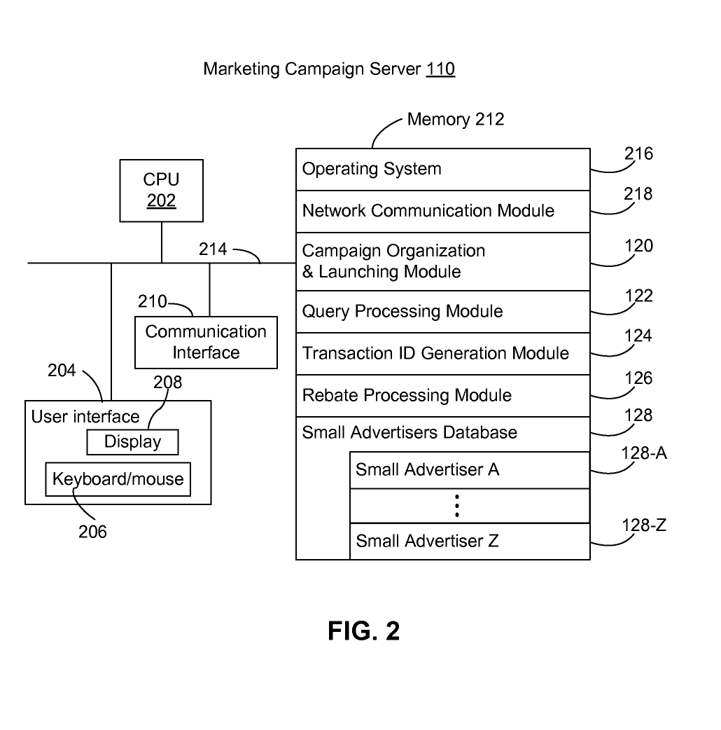

FIG. 2 is a block diagram illustrating the components of the TV marketing campaign server 110 configured for launching a generic, brand-neutral marketing campaign for a plurality of small advertisers in accordance with some implementations. The marketing campaign server 110 includes one or more processing units (CPU's) 202 for executing modules, programs and/or instructions stored in memory 212 and thereby performing processing operations; one or more network or other communications interfaces 210; memory 212; and one or more communication buses 214 for interconnecting these components. In some implementations, the marketing campaign server 110 includes a user interface 204 comprising a display device 208 and one or more input devices 206 (e.g., keyboard or mouse). In some implementations, the memory 212 includes high-speed random access memory, such as DRAM, SRAM, DDR RAM or other random access solid state memory devices. In some implementations, the memory 212 includes non-volatile memory, such as one or more magnetic disk storage devices, optical disk storage devices, flash memory devices, or other non-volatile solid state storage devices. In some implementations, the memory 212 includes one or more storage devices remotely located from the CPU(s) 202. Memory 212, or alternately the non-volatile memory device(s) within memory 212, comprises a computer readable storage medium, which does not include a transitory signal. In some implementations, memory 212 or the computer readable storage medium of memory 212 stores the following programs, modules and data structures, or a subset thereof, and may also include additional elements:
an operating system 216 that includes procedures for handling various basic system services and for performing hardware dependent tasks;
a network communications module 218 that is used for connecting the marketing campaign server 110 to other computers (e.g., the client devices 102 including the small advertisers 105 and the TV broadcasters 108) via the communication network interfaces 210 and one or more communication networks (wired or wireless), such as the Internet, other wide area networks, local area networks, metropolitan area networks, and so on;
a campaign organization and launching module 120 for soliciting a plurality of small advertisers 105 to register for a generic, brand-neutral marketing campaign and causing the broadcast of the marketing campaign towards a large audience pool through one or more TV broadcasters 108;
a query processing module 122 for receiving search queries from client devices 102 for the products or services promoted by marketing campaign server 110 and recommending one or more small advertisers, if any, to each requesting client device 102 based on, e.g., the location of the client device;
a transaction ID generation module 124 for generating a unique transaction ID in response to a request from a client device 102 to purchase a product or service from a small advertiser that participates in the marketing campaign and optionally including the unique transaction ID in a purchase coupon made accessible to a user who submits the request from the client device 102;
a rebate processing module 128 for providing rebates to respective advertisers that participate in the marketing campaign based on the number of unique transaction IDs that are generated by the transaction ID generation module 124 and redeemed at the respective advertisers; and
a small advertisers database 128 including information about a plurality of small advertisers 128-A to 128-Z, such as the location and contact information of an advertiser, information about the product/service that the advertiser promotes, the marketing campaigns in which the advertiser participates, etc. As each entry in the small advertiser database 128 is associated with a respective small advertiser, the marketing campaign server 110 uses the information therein to invite advertisers to participate in/bid on a marketing campaign and charges service fees to the participant advertisers based on services rendered.

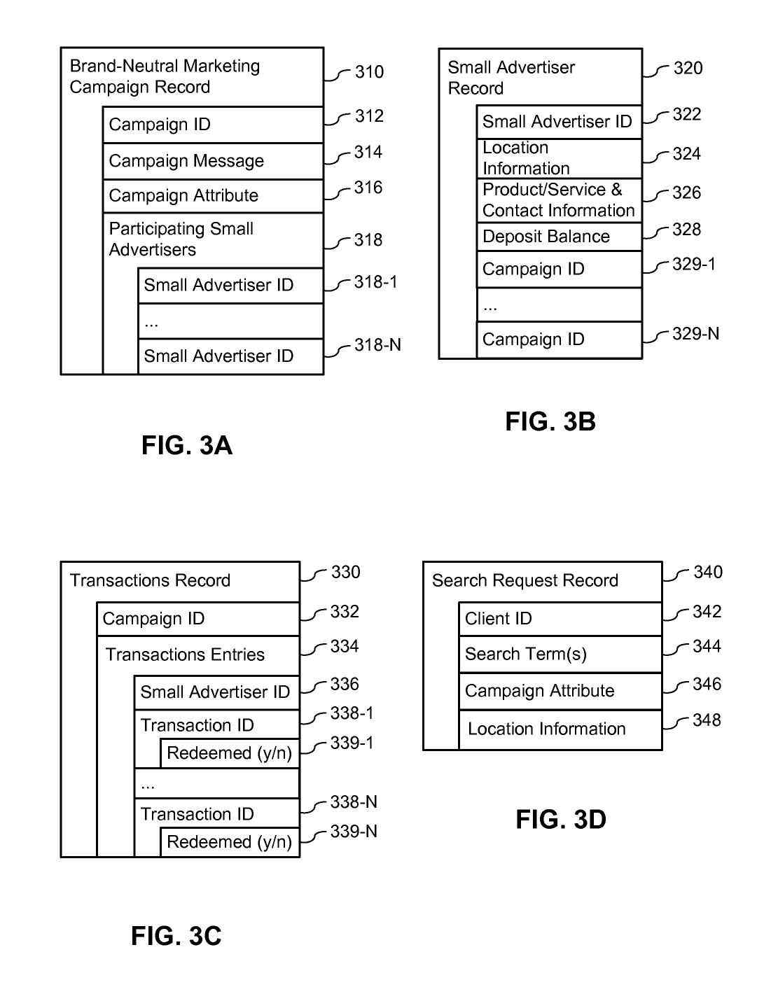

FIGS. 3A to 3C are block diagrams illustrating data structures used by the marketing campaign server 110 for launching a generic, brand-neutral marketing campaign for a plurality of small advertisers and facilitating a target-oriented commercial transaction between an individual and a small advertiser in accordance with some implementations.

For each marketing campaign, the marketing campaign server 110 (or the campaign organization and launching module 120) generates brand-neutral marketing campaign record 310. This record includes a unique campaign ID 312, a campaign message 314, a campaign attribute 316, and a plurality of advertiser IDs 318-1 to 318-N for identifying those small advertisers that participate in the marketing campaign. In some implementations, the campaign message 314 may be one of an audio stream, a video stream, a text message, or a combination thereof. Regardless of its exact format, the campaign message 314 is designed to deliver a generic, brand-neutral message to the TV audiences that watch the marketing campaign about a particular product or service provided by the small advertisers that participate in the marketing campaign. For example, one exemplary campaign message is “Get 20% off when ordering a hot pizza from your local pizzeria NOW.” This message does not have any brand-specific information to promote a particular pizza store so that it can be used for promoting a large number of independent, small pizza stores at different communities that do not rely on a strong branding to attract its customers. But the campaign message 314 alone may not provide enough information on how to order the promoted product or service.

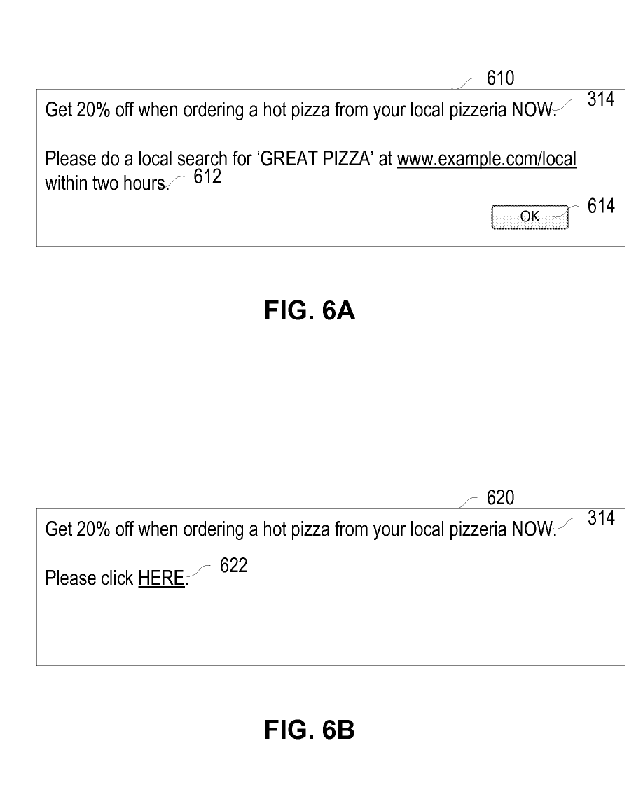

The campaign attribute 316 is an information item within a marketing campaign that supplements the campaign message 314 and provides instructions on how to order the promoted product or service. As shown in FIG. 6A, the exemplary user interface is a text box 610 that appears on the TV (without the “OK” button 614) or the display of a client 102 (e.g., a laptop/desktop computer or a mobile device) and includes the exemplary pizza promotion campaign message 314, which is followed by the instruction 612 “Please do a local search for ‘GREAT PIZZA’ at www.example.com/local within two hours.” A viewer of this campaign message can enter the hyperlink and the specific search term in the instruction 612 into a web browser application and submit a search request to a web server at www.example.com/local. In this example, the web server is a search engine that has been programmed in advance so that it treats the search term “GREAT PIZZA” in a special manner by identifying one of the participant advertisers adjacent a user who submits the search term within two hours after broadcasting the marketing campaign on the TV. As shown in FIG. 6B, the exemplary user interface is a text box 620 that includes the exemplary pizza promotion campaign message 314, which is followed by the instruction 622 “Please click HERE.” In this example, the letter “HERE” has an embedded vanity URL (e.g., http://www.example.com/GREAT-PIZZA) that corresponds to the campaign attribute 316. A user can order the product or service by clicking the hyperlink associated with this vanity URL, which sends a search request to a corresponding web server. In either case, the web server associates the search request with a campaign record 310 that has the campaign attribute 316. In some implementations, the campaign attribute 316 includes an account registered at a social networking website and a short text message. A user who wants to make a purchase needs to send the short text message to the account and wait for the response that includes information about a nearby store that offers the promoted product or service. In some implementations, the campaign attribute 316 may be embedded in the campaign message 312.

The small advertiser IDs 318-1 to 318-N identify those advertisers that have participated in this particular campaign, each corresponding an advertiser entry in the small advertisers database 128. FIG. 3B depicts one exemplary small advertiser record 320 stored in the database 128. The record 320 includes a small advertiser ID 322, location information 324, product/service and contact information 326, deposit balance 328, and one or more campaign IDs 329-1 to 329-N. The small advertiser ID 322 is used by the campaign organization and launch module 120 for identifying a participant advertiser. The location information 324 is used for determining which, if any, advertiser may be recommended to a requesting user based on the user's current location (e.g., the location of a client device 102 from which the user request is submitted). The product/service and contact information 326 is provided to the requesting user for further communication with the advertiser, if necessary. The deposit balance 328 is the amount of money prepaid by the advertiser. For example, in some implementations the marketing campaign server 110 may charge a participant advertiser an entrance fee for each marketing campaign in which that advertiser participates. In some implementations, the fee amount may vary from one campaign to another campaign for the same advertiser or from one advertiser to another advertiser for the same campaign. The campaign IDs 329-1 to 329-N are the marketing campaigns in which the advertiser has participated.

FIG. 3D is a block diagram illustrating a data structure used by a client device for submitting a search request for a product or service promoted by a generic, brand-neutral marketing campaign in accordance with some implementations. In this example, the search request record 340 includes a client ID 342, one or more search terms 344, a campaign attribute 346, and location information 348. In some implementations, the client ID 342 is a unique identifier of a client device 102 that sends out the search request record 340, which could be a telephone number of a mobile phone or an IP address of a laptop/desktop computer. The search terms 344 include, e.g., the term “GREAT PIZZA” and other user-provided terms at the client device. For example, the user may enter the term “pepperoni” into the search box at the client 102. As noted above, either the special search term 344 or the campaign attribute 346 or both may be used by the marketing campaign server 110 to identify a marketing campaign record 310. Finally, the location information 348 is used by the marketing campaign server 110 to identify those advertisers 318 that are proximate to the current location of the client 102. In some implementations, the location information could be provided by a second application (e.g., a GPS sensor) running on the client 102. For example, the web browser running on a mobile phone can pick up the GPS information and send that back to the server. In some other implementations, the server could infer the current location from the IP address from which the request is submitted. In some implementations, the user of the client device 102 logs into an account associated with a particular location to provide its current location information.

As noted above, when a user chooses to order the product or service from a particular advertiser, the marketing campaign server 110 (or the transaction ID generation module 124) generates a unique transaction ID for the particular advertiser. Such information is stored in a transactions record 330 shown in FIG. 3C. The transactions record 330 is associated with a particular marketing campaign identified by the campaign ID 332 and includes a plurality of transaction entries 334. The plurality of transaction entries 334 are further grouped by small advertisers identified by the advertiser IDs. Each advertiser ID 336 is associated with one or more transaction IDs 338-1 to 338-N and each transaction ID further includes an attribute 339-1 to 339-N indicating whether the advertiser has redeemed the rebate from the marketing campaign server 110.

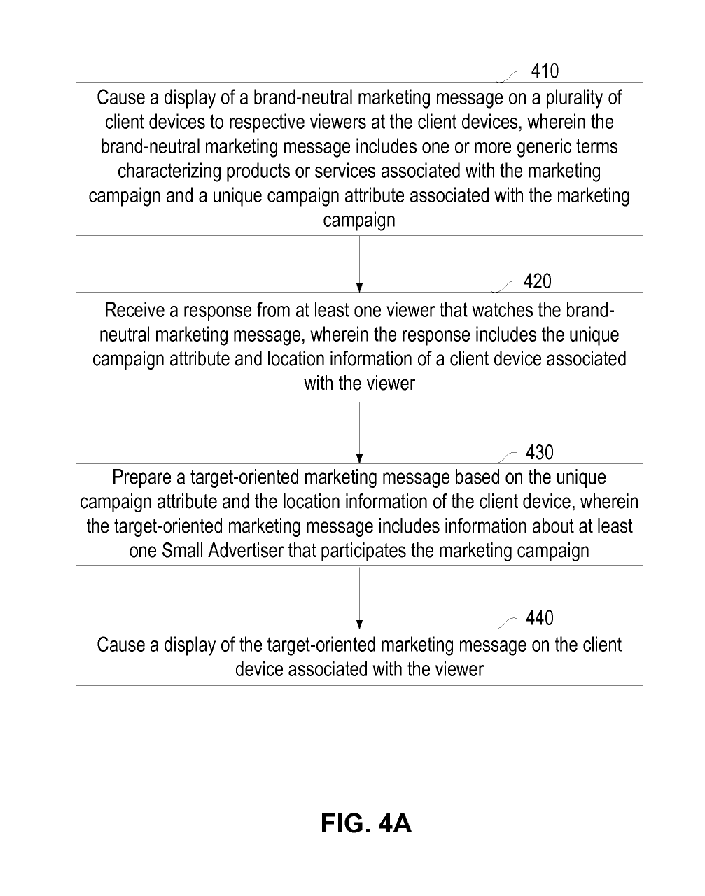

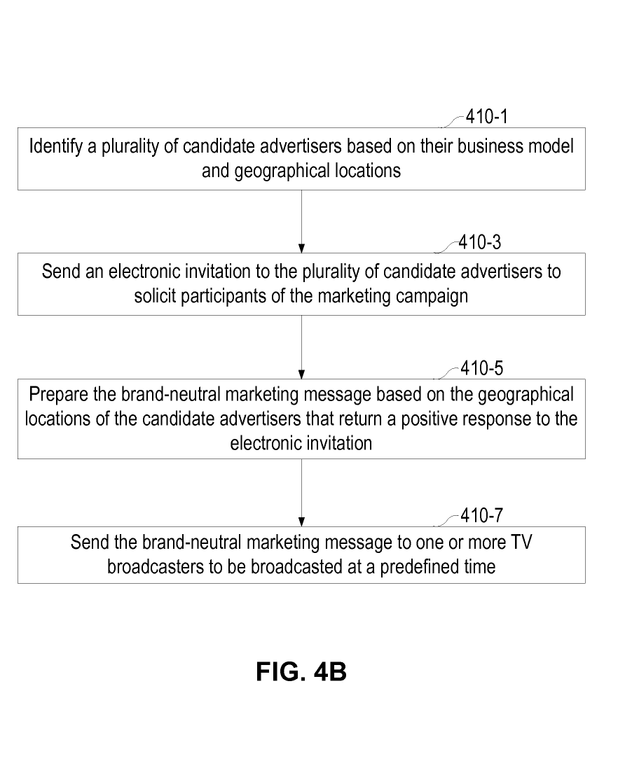

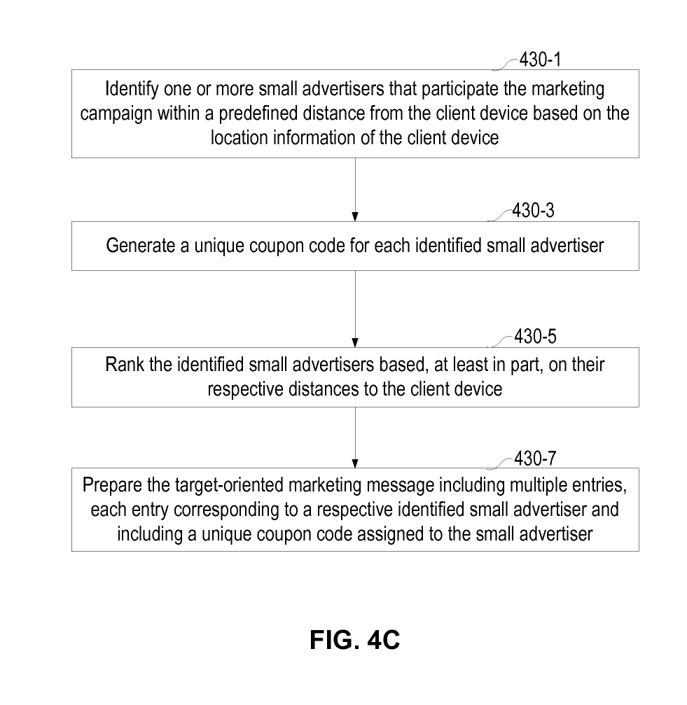

FIGS. 4A to 4C are flow charts illustrating how the TV marketing campaign server 110 launches a generic, brand-neutral marketing campaign for a plurality of small advertisers in accordance with some implementations. As noted above, a prerequisite for launching such marketing campaign is that a predefined number of advertisers having a sufficient geographical coverage have agreed to participate in the campaign.

Subsequently, the marketing campaign server 110 prepares a brand-neutral marketing message using one or more generic terms characterizing the products or services provided by the participant advertisers and requests one or more TV broadcasters to broadcast the marketing message at a predefined time. As such, the marketing campaign server 110 causes (410) a display of the brand-neutral marketing message on a plurality of client devices to respective viewers at the client devices. In some implementations, the brand-neutral marketing message includes not only one or more generic terms characterizing products or services associated with the marketing campaign but also a unique campaign attribute associated with the marketing campaign. The one or more generic terms are commonly used by the public for characterizing a specific product or service provided by the small advertisers (e.g., “hot delicious pizza” or “fast dry cleaning service”) and the unique campaign attribute is, for example, one selected from the group consisting of an offer code, a vanity URL, and a predefined search term.

FIG. 4B further depicts how the marketing campaign server 110 organizes the marketing campaign in accordance with some implementations. First, the server 110 identifies (410-1) a plurality of candidate advertisers based on their business model and geographical locations. Next, the server 110 sends (410-3) an electronic invitation to the plurality of candidate advertisers to solicit participants of the marketing campaign. After receiving positive responses from a sufficient number of advertisers, the server 110 prepares (410-5) the brand-neutral marketing message based on the geographical locations of the candidate advertisers that agrees to join the marketing campaign. Depending on the distribution of these geographical locations, the advertisements associated with the marketing campaign can be broadcast with national coverage or regional coverage. Finally, the server 110 sends (410-7) the brand-neutral marketing message to one or more TV broadcasters to be broadcasted at a predefined time. In some implementations, the marketing campaign server 110 may limit the number of participants within a geographical area if there are too many advertisers from this area that would like to participate in the campaign. In some other implementations, the marketing campaign server 110 may give up the campaign if there are not enough participants from many commercially critical areas. In this case, the server 110 returns any deposit from those advertisers that have agreed to participate in the campaign.

After the broadcast of the marketing message, some viewers who have watched the message may choose to buy the promoted products or services by submitting a predefined search query (e.g., a query specifying one or more predefined keywords associated with the campaign or a unique campaign ID), visiting a website identified by the campaign message. Next, assume that the server 110 receives (420) a response from at least one viewer that has watched the brand-neutral marketing message. In some implementations, the response includes the unique campaign attribute and location information of a client device associated with the viewer. Since the marketing campaign involves a plurality of small advertisers at different geographical locations, the server 110 need to know the approximate location of the client device that submits the response so that it can recommend a small advertiser close to the client device. Depending on the different types of client devices such as a TV having access to the Internet, a desktop or laptop or tablet computer, and a smart phone, the location of a client device may be determined in accordance with an IP address associated with the client device, a ZIP code associated with a TV viewership account, or a GPS signal captured by a mobile device such as a smart phone.

Based on the geographical location of the client device, the marketing campaign server 110 prepares (430) a target-oriented marketing message based on the unique campaign attribute and the location information of the client device. In some implementations, the target-oriented marketing message includes information about at least one small advertiser that participates in the marketing campaign. For example, the target-oriented marketing message may be a one-box search result that is commonly found in the search results returned by a search engine. The search result may further include a unique coupon code generated for the client device responding to the marketing message.

FIG. 4C further depicts how the server 110 prepares the target-oriented marketing message in accordance with some implementations. First, the server 110 identifies (430-1) one or more small advertisers that participate in the marketing campaign and that are within a predefined distance from the client device based on the location information of the client device. In other words, there may be more than one advertiser participating in the marketing campaign within a short distance (e.g., 5 miles) from the client device. For each identified small advertiser, the server 110 generates (430-3) a unique coupon code. Next, the server 110 ranks (430-5) the identified small advertisers based on their respective distances to the client device and their generic popularities and prepares (430-7) the target-oriented marketing message including multiple entries, each entry corresponding to a respective identified small advertiser and including a unique coupon code assigned to the small advertiser. In some implementations, if there is no small advertiser that participates in the marketing campaign that is within the predefined distance from the client device based on the location information of the client device, the server 110 asks the search engine to provide a set of local search results to be returned to the client device based on the one or more generic terms characterizing products or services and the location information of the client device. In other words, the set of local search results is a default response by the marketing campaign server 110 if no participant advertiser is close enough to the client device.

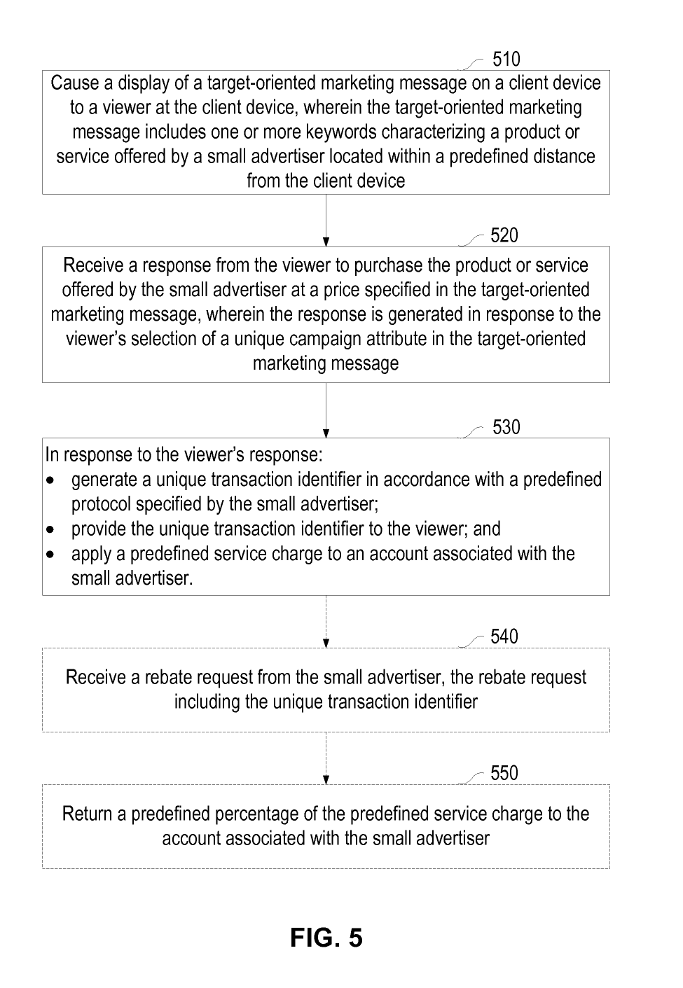

Finally, the server 110 returns the target-oriented marketing message to the client device and causes (440) a display of the target-oriented marketing message on the client device associated with the viewer. Note that the generic brand-neutral marketing message and the target-oriented marketing message serve different purposes. The brand-neutral marketing message promotes a generic product or service to a large number of audiences in an undiscriminating manner. On top of that, the target-oriented marketing message focuses on a particular viewer who has watched the brand-neutral marketing message and expressed an interest in using the promoted product or service by sending a follow-up response to the marketing campaign server 110. After receiving and viewing the target-oriented marketing message, the viewer has two choices: either ignoring the target-oriented marketing message or following the target-oriented marketing message to order the product or service from a local small advertiser as described below in connection with FIG. 5.

FIG. 5 is a flow chart illustrating how the TV marketing campaign server 110 facilitates a transaction between an individual (e.g., a viewer of a target-oriented marketing message) and a small advertiser through the target-oriented marketing campaign in accordance with some implementations. Note that the process shown in FIG. 5 is not limited to the TV/web hybrid marketing approach described in the present application and it is also applicable to any web-based marketing event regardless of whether there is any involvement of TV broadcasting or not. But for illustrative purposes, the example below is assumed to be a continuation of the process shown in FIG. 4.

After causing (510) a display of a target-oriented marketing message on a client device to a viewer at the client device, the marketing campaign server 110 receives (520) a response from the viewer to purchase the product or service offered by the small advertiser at a price specified in the target-oriented marketing message. In some implementations, the target-oriented marketing message includes one or more keywords characterizing a product or service offered by a small advertiser located within a predefined distance from the client device. For example, the marketing message is to promote a local pizzeria. In other words, the target-oriented marketing message is prepared for the viewer based on a current location of the client device, which is determined in accordance with an IP address, a ZIP code, a GPS signal, a known transmitter location that is proximate to the client device, or other location information associated with the client device. If the viewer is interested in its service, the viewer can generate the response by selecting a unique campaign attribute in the target-oriented marketing message.

In response to the viewer's response (530), the marketing campaign server 110 generates a unique transaction identifier in accordance with a predefined protocol specified by the small advertiser, provides the unique transaction identifier to the viewer, and applies a predefined service charge to an account associated with the small advertiser. For example, the marketing campaign server 110 generates an electronic coupon for a viewer who has responded to the target-oriented marketing message delivered to the viewer. The electronic coupon includes a unique transaction identifier associating the viewer with the small advertiser whose product or service is of interest to the viewer. In some implementations, the transaction identifier may be a unique alphanumerical text string, a 1-D bar code, or a 2-D bar code. As described above, this unique transaction identifier serves at least two purposes. First, the viewer can redeem the electronic coupon (or a paper copy thereof) including the unique transaction identifier at the small advertiser for the desired product or service at a price announced in the target-oriented marketing message. Sometimes, the advertiser may include a discount in the price (e.g., 20% off) to encourage business traffic from the viewers of the target-oriented marketing messages. Second, as noted above, the generation of this unique transaction identifier enables the marketing campaign server 110 to charge a predefined amount of service fee for the marketing service rendered to the small advertiser.

In some implementations, although the small advertiser does not know exactly what transaction identifiers have been generated, the marketing campaign server 110 should use an algorithm acceptable to the small advertiser for generating the transaction identifier because the small advertiser has to be able to authenticate the transaction identifier on a coupon provided by the viewer when the viewer redeems the coupon with the advertiser (which may happen at the advertiser's physical site or website). Moreover, the marketing campaign server 110 is configured to generate different transaction identifiers for different viewers that have watched the target-oriented marketing message at different client devices. For example, in some implementations, different viewers have coupons with different transaction identifiers when they visit the same advertiser for its promoted product or service. This feature makes it possible for both the marketing campaign server 110 and the advertiser to keep track of the number of commercial transactions at the advertiser due to the TV- and web-based hybrid marketing campaign. Using this number, not only the advertiser can appreciate how effective this marketing tool is but also the marketing campaign server 110 can charge an accurate amount of service fee to the advertiser based on the amount of business that the advertiser can benefit from the campaign.

In some implementations, the marketing campaign server 110 provides a further incentive to a small advertiser to use its service by providing a rebate to the advertiser based on the number of commercial transactions it helps complete. For example, at predefined time such as every night or every week, the marketing campaign server 110 receives (540) a rebate request from the small advertiser. In some implementations, the rebate request includes a plurality of unique transaction identifiers that the advertisers has collected from the viewers who redeem their coupons with the advertiser, one of which being the unique transaction identifier from the particular viewer mentioned above. Based on the number of unique transaction identifiers, the marketing campaign server 110 then returns (550) a predefined rebate to the small advertiser from the service fee it has charged from the small advertiser. In some implementations, a small advertiser has a deposit account with the marketing campaign server 110. When the marketing campaign server 110 charges a service fee from the advertiser, it can withdraw a predefined amount of money from the account. When the marketing campaign server 110 returns a rebate to the advertiser, it can redeposit a predefined amount of money back into the account. There are different ways of calculating the rebate. For example, the marketing campaign server 110 may give a predefined percentage (e.g., 15%) of the service fee back to the advertiser as a rebate and the percentage may increase when the advertiser receives more business traffic because of the hybrid marketing campaign.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

What is claimed is:

1. A method of facilitating a transaction between an individual and a small advertiser through a target-oriented marketing campaign, comprising:
at a server system having memory and one or more processors:
causing a display of a target-oriented marketing message on a client device to a viewer at the client device, wherein the target-oriented marketing message includes one or more keywords characterizing a product or service offered by a small advertiser located within a predefined distance from the client device;
receiving a response from the viewer to purchase the product or service offered by the small advertiser at a price specified in the target-oriented marketing message, wherein the response is generated in response to the viewer's selection of a unique campaign attribute in the target-oriented marketing message; and
in response to the viewer's response:
generating a unique transaction identifier in accordance with a predefined protocol specified by the small advertiser;
providing the unique transaction identifier to the viewer; and
applying a predefined service charge to an account associated with the small advertiser.

2. The computer-implemented method of claim 1, further comprising:
receiving the unique transaction identifier from the small advertiser; and
returning a predefined rebate to the small advertiser from the account associated with the small advertiser.

3. The computer-implemented method of claim 2, wherein the small advertiser receives the unique transaction identifier from the viewer in connection with conducting a commercial transaction with the viewer.

4. The computer-implemented method of any of claim 1, wherein the server system is configured to generate different transaction identifiers for different viewers that have watched the target-oriented marketing message at different client devices.

5. The computer-implemented method of any of claim 1, wherein the target-oriented marketing message is prepared for the viewer based on a current location of the client device.

6. The computer-implemented method of claim 5, wherein the current location information of the client device is determined in accordance with one selected from the group consisting of an IP address, a ZIP code, and a GPS signal.

7. The computer-implemented method of any of claim 1, wherein the transaction identifier is an electronic coupon including one selected from the group consisting of a unique alphanumerical text string, a 1-D bar code, or a 2-D bar code.

8. The computer-implemented method of any of claim 1, wherein the target-oriented marketing message is a one-box search result, including information about the small advertiser.

9. The computer-implemented method of any of claim 1, wherein the client device is one selected from the group consisting of a TV having access to the Internet, a desktop or laptop or tablet computer, and a smart phone.

10. A computer system, comprising:
one or more processing units; and
memory storing one or more programs to be executed by the one or more processing units, the one or more programs comprising instructions for:
causing a display of a target-oriented marketing message on a client device to a viewer at the client device, wherein the target-oriented marketing message includes one or more keywords characterizing a product or service offered by a small advertiser located within a predefined distance from the client device;
receiving a response from the viewer to purchase the product or service offered by the small advertiser at a price specified in the target-oriented marketing message, wherein the response is generated in response to the viewer's selection of a unique campaign attribute in the target-oriented marketing message; and
in response to the viewer's response:
generating a unique transaction identifier in accordance with a predefined protocol specified by the small advertiser;
providing the unique transaction identifier to the viewer through the client device; and
applying a predefined service charge to an account associated with the small advertiser.

11. The computer system of claim 10, further comprising instructions for:
receiving the unique transaction identifier from the small advertiser; and
returning a predefined rebate to the small advertiser from the account associated with the small advertiser.

12. The computer system of any of claim 10, wherein the server system is configured to generate different transaction identifiers for different viewers that have watched the target-oriented marketing message at different client devices.

13. The computer system of any of claim 10, wherein the target-oriented marketing message is prepared for the viewer based on a current location of the client device.

14. The computer system of any of claim 10, wherein the transaction identifier is an electronic coupon including one selected from the group consisting of a unique alphanumerical text string, a 1-D bar code, or a 2-D bar code.

15. The computer system of any of claim 10, wherein the client device is one selected from the group consisting of a TV having access to the Internet, a desktop or laptop or tablet computer, and a smart phone.

16. A computer readable storage medium storing one or more programs configured for execution by a computer system, the one or more programs comprising instructions for:
causing a display of a target-oriented marketing message on a client device to a viewer at the client device, wherein the target-oriented marketing message includes one or more keywords characterizing a product or service offered by a small advertiser located within a predefined distance from the client device;
receiving a response from the viewer to purchase the product or service offered by the small advertiser at a price specified in the target-oriented marketing message, wherein the response is generated in response to the viewer's selection of a unique campaign attribute in the target-oriented marketing message; and
in response to the viewer's response:
generating a unique transaction identifier in accordance with a predefined protocol specified by the small advertiser;
providing the unique transaction identifier to the viewer; and
applying a predefined service charge to an account associated with the small advertiser.

17. The computer readable storage medium of claim 16, further comprising instructions for:
receiving the unique transaction identifier from the small advertiser; and
returning a predefined rebate to the small advertiser from the account associated with the small advertiser.

18. The computer readable storage medium of any of claim 16, wherein the server system is configured to generate different transaction identifiers for different viewers that have watched the target-oriented marketing message at different client devices.

19. The computer readable storage medium of any of claim 16, wherein the target-oriented marketing message is prepared for the viewer based on a current location of the client device.

20. The computer readable storage medium of any of claim 16, wherein the transaction identifier is an electronic coupon including one selected from the group consisting of a unique alphanumerical text string, a 1-D bar code, or a 2-D bar code.

21. The computer readable storage medium of any of claim 16, wherein the client device is one selected from the group consisting of a TV having access to the Internet, a desktop or laptop or tablet computer, and a smart phone.
